(19) United States
(12) Patent Application Publication
(10) Pub. No.: US 2002/0094800 A1
(43) Pub. Date: Jul. 18, 2002

(54) Paging system with 'calling party pays' and other advanced features

(76) Inventors: David Trop, Newark, NJ (US); Eli Silberstein, Newark, NJ (US)

Correspondence Address: GOTTLIEB RACKMAN & REISMAN PC, 270 MADISON AVENUE, 8TH FLOOR, NEW YORK, NY, 100160601

(21) Appl. No.: 09/761,454

(22) Filed: Jan. 16, 2001

(51) Int. Cl. H04M 11/00

(52) U.S. Cl. 455/406; 455/426

(57) ABSTRACT

A paging system is arranged to deliver a page from a caller to a subscriber with an optional vocal message being transcribed into a digital message. The identity of the caller and the digital message, if any, are shown on the screen of a pager associated with the subscriber. The subscriber can contact the caller by calling a special number which is not necessarily the same number as the caller's telephone number. The subscriber is then automatically connected to the caller. The cost of the page and the return call can be charged to either the subscriber or the caller.

### BACKGROUND OF THE INVENTION

A. Field of Invention

This invention pertains to an improved paging system, and more particularly to a system in which, the calling party pays for the total cost of a call to a pager. The system includes several other features, such as ‘hold-to-talk’ which allows the paged subscriber to be automatically connected to the caller, and an automated text transcribing service which allows text messages to be sent to a pager.

B. Description of the Prior Art

Typically a person subscribes to a paging service and receives a pager with an alphanumeric display. A caller can then place a call to a central station and leave his own telephone number and/or a brief message to the subscriber. Most often, the caller requests that the subscriber call him back. The message is then transmitted to the pager which stores it in its memory and emits some signal to the subscriber to indicate that a message has been received. The subscriber can then read the message on the alphanumeric display.

Because of their convenience, pagers have become very popular and have found hundreds of uses associated with business as well as personal activities. Originally these devices were relatively large and heavy. However advances in electronics resulted in much smaller devices making them more popular than ever before.

A problem with existing systems is that it requires the subscriber to pay not only for the paging service but also for every telephone call that he makes in response to a message received through the pager. However, in some situations a caller may prefer to pay for both the pager service and the return call. For example, pagers are frequently given parents to their children to keep in touch. However, if a parent sends a message to a child, and if the child does not have change and cannot use a public telephone, the whole purpose of providing a pager is defeated. In another situation a businessman may call a client on a pager. In this situation, it is more appropriate for the businessman to pay for his client's return call. Otherwise, very frequently the client ignores such messages if he has to pay for the return call.

A further disadvantage of existing systems is that once a caller leaves his message and hangs up, he may initiate a call to another person, or may get involved in other activities so that by the time the subscriber gets back to him the caller is unavailable. The subscriber must then leave a message to the caller (if some kind of answering service is in place). In this manner the caller and the subscriber can ‘play tag’ for an extended time period before they can finally talk to each other.

A ‘calling party pays pager’ system in which a caller could pay for messages was operational in Chicago, Ill., however it did not address all the disadvantage discussed above.

### Objectives and Summary of the Invention

An objective of the present invention is to provide a paging system in which a caller pays for messages to a subscriber in an efficient manner.

A further objective is to provide a paging system in which when a caller sends a message to a subscriber, a return connection can be established automatically between the subscriber and the caller.

A further objective is to provide a paging system in which, optionally, the caller pays automatically for the return call from the subscriber.

Yet another objective is to provide a paging system in which oral messages are transcribed off line into a corresponding alphanumeric text which is then transmitted to the subscriber.

Other objectives and advantages of the invention will become apparent from the following description. Briefly, a paging system constructed in accordance with this invention includes paging server, a payment server and a conference switch. These elements may be implemented as a single unit. However, they are described herein as being separate components for the sake of clarity.

A message or a page from a caller is received by the paging server. The paging server then contacts the payment server to determine if payment can be charged to and collected from the caller for the page (and a responsive return call, if any). If the caller cannot be charged, the page is not sent. Alternatively, the subscriber may be given the choice for payment options when he signs up for the service or at a later time. For example, the subscriber may elect to pay for some pages dependent on the identity of the caller and/or other criteria. Other pages must be paid for in full by the caller.

In another aspect of the invention, the subscriber receives a special number for responding to the page. This special number may be a toll-free number, in which case the caller pays for the return call, and may be permanently assigned to the subscriber, or may be assigned just for responding to this particular call. A call from the subscriber using this special number is routed to a conference switch which then establishes automatically a voice channel between the subscriber and the caller. Preferably, after the caller places the page, she is put on hold until the subscriber places the return call. The two calls are then conferenced by the conference switch.

In another aspect of the invention, the system may be adapted to receive voice messages from a caller. This voice message may be stored for retrieval by the subscriber, or it may be sent to a transcription station where it is converted to a digital message. The digital message is then transmitted with the page to the pager and shown on its display. The voice message can be transcribed by attendants or by using speech recognition software.

### BRIEF DESCRIPTION OF THE DRAWINGS

FIG. 1 shows a block diagram of a standard paging system in which the subscriber pays for incoming pages and return calls;

FIG. 2 shows a block diagram of a paging system in accordance with the present invention wherein the caller pays for pages and for return telephone connection between the caller and the subscriber;

FIG. 3 shows a flow chart illustrating the operation of the paging system of FIG. 2;

FIG. 4A shows a flow chart for the ‘calling party pays’ mode of operation of the paging systems of FIGS. 2 and 3;

FIG. 4B shows a flow chart showing a mode of operation of the paging system of FIGS. 2 and 3 with the subscriber paying for pages;

FIG. 5 shows a flow chart for generating digital messages from oral messages by the paging system of FIGS. 2 and 3;

FIG. 6 shows a schematic diagram of a conference switch for the paging system of FIGS. 2 and 3; and

FIG. 7 shows a flow chart for establishing a voice channel between the subscriber and the caller using the paging system of FIGS. 2, 3 and 6.

### DETAILED DESCRIPTION OF THE INVENTION

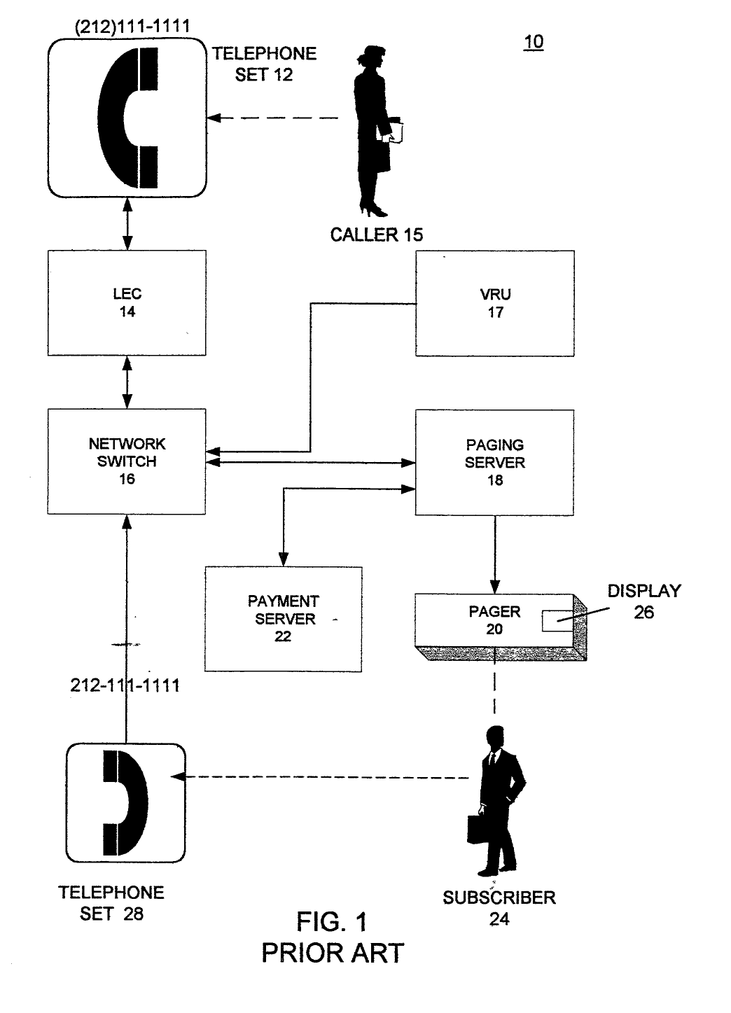

A prior art paging system 10 is shown in FIG. 1. The system includes a standard telephone 12, a local exchange carrier 14, a network switch 16, an optional voice response unit (VRU) 17, a paging server 18 and at least one pager 20. In this standard paging system, each pager 20 is designated by a personal telephone number (PTN). In other systems, the paging server may be serving a plurality of pagers, but it may itself have a single telephone number. Additional numbers or other indicia may be used to route pages to the individual pagers.

In one mode of operation, caller 15 can send a page to subscriber 24 as follows. First, the caller 15 dials the PTN associated with pager 20. The call goes through the LEC 14 to the network switch 16. The network switch transmits the call to paging server 18. The paging server returns a signal to the telephone set 12 requesting the page. The caller 15 hears this signal and enters the telephone number of set 12 (i.e., 212-111-1111). The paging server 18 then sends this number as a page to pager 20. The pager 20 then generates an aural, tactile and/or visual signal to subscriber 24 to indicate that a page has been received and displays shows the number of set 12 on display 26.

Next, the subscriber 24 finds a telephone 28 (or uses his wireless telephone, if one is available) and calls the number of telephone set 12. The call is routed by the LEC 14 in the conventional manner, the telephone set 12 rings, the caller 15 picks up the hand set and the two parties can talk to each other.

A more sophisticated system may obtain the caller ID from the telephone set 12 so that caller 15 may not need to enter the number of set 12 manually.

In another configuration, when a call for a page is received, the network switch 16 activates the VRU 17 which then provides instructions to the caller 15 to enter the telephone number of set 12. If the telephone set 12 has the capability of receiving alphanumeric characters from the caller 15, these characters may be added to the page and displayed by pager 20 as well.

In this standard paging system the subscriber 24 is charged for the paging service and/or for each page. This payment is managed by the payment server 22. The subscriber 24 is further charged for the cost of the standard return call between the telephone set 26 and the telephone set 12. The caller 15 is charged for calling the subscriber 24 in the normal manner.

As previously mentioned, the applicants are aware of a ‘calling party pays’ system in which the subscriber 24 pays an initial fee for the pager 20 however he does not pay for each page, but instead the calling party is charged. This prior art system operated as follows. When the caller 15 placed a page to pager 22, the call was routed to the paging server 18 in the usual manner. However in this case, before the page was completed, the paging server 18 sent a message to payment server 22. The payment server 22 sent a voice message back to the telephone set 12 indicating to the caller 15 that he will be charged for the page and requesting his approval for the same. If the caller 15 approved (by pressing, for example, a button on set 12) then the payment server 22 sent a message to LEC 14 indicating that the account of telephone set 12 was to be charged for the cost of the page. If the LEC 14 accepted the charge, the payment server 22 sent a command to paging server 18 to issue the page to pager 20. Otherwise, the call to the pager 20 was declined. Once the subscriber 24 received the page, he then called the telephone set using set 28 in the usual manner.

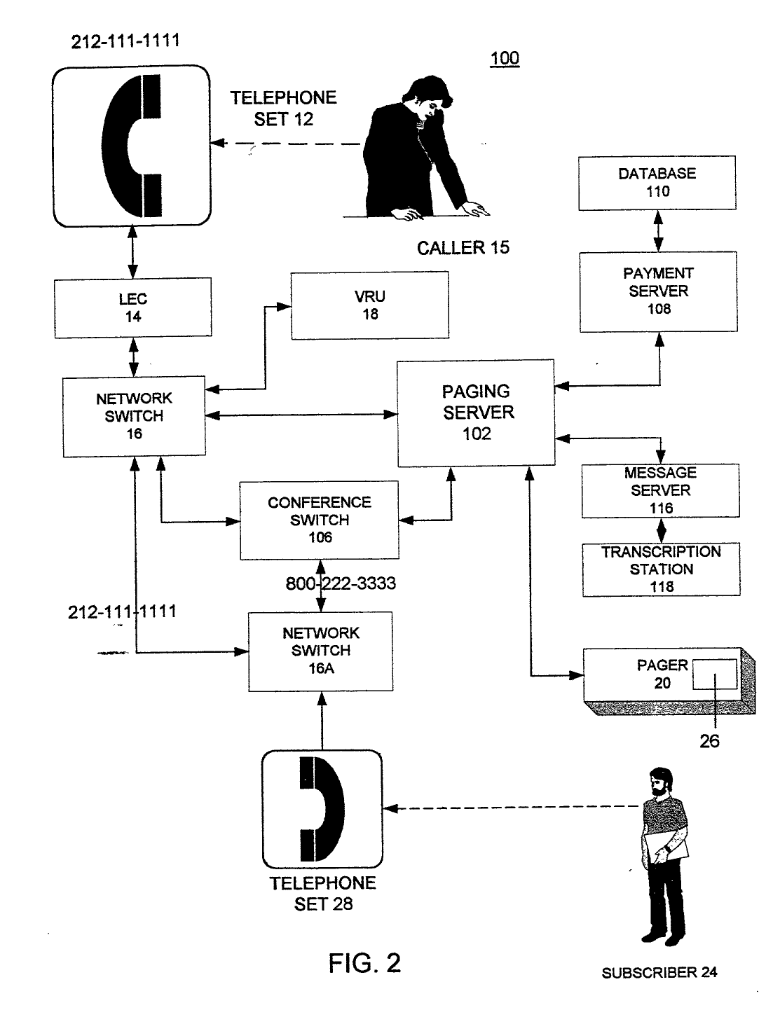

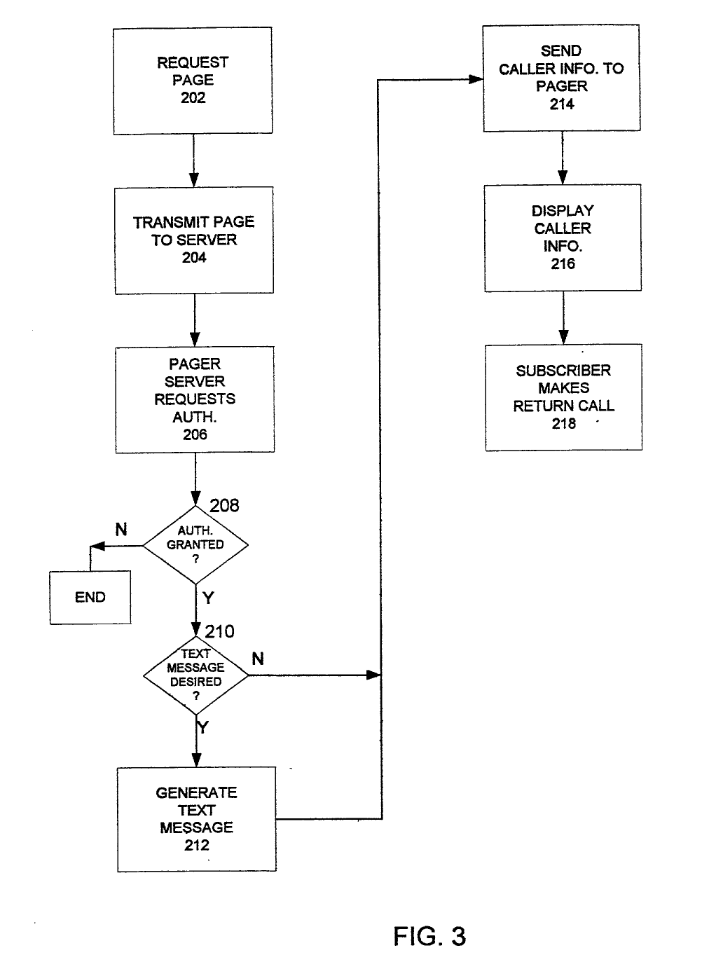

Referring now to FIGS. 2 and 3, in the present invention system 100 is similar to the system 10 in FIG. 1. System 100 paging is performed using a paging server 102, a pager 104, conference switch 106 and payment server 108. In addition, the system is also adapted to receive oral messages and convert the same into text, using a message server 116 and a transcription station 118. In addition, the system 100 may also be adapted to establish automatically a communication path for a return call from the subscriber 24 through a network switch 18A and a conference switch 106. The pager 20 used in system 100 is identical to the pagers 20 used in the standard pager systems. The major difference in the system is that the subscriber only pays a nominal fee (if any) for the pager itself, and, in the preferred embodiment, does not pay for any pages. Rather the calls are paid for by the caller. A further important feature of the invention is that once the page is placed, the caller does not have to hang up and wait but instead can wait on line while the subscriber makes the return call. The two parties are then conferenced and can talk to each other.

The operation of the system 100 is best explained in conjunction with the flow chart of FIG. 3. In step 200 caller 15 dials the PTN to place a page to pager 20 on telephone set 12. In step 202 the PTN number and other data identifying telephone set 12 and/or caller 15 are sent to the paging server 102 through LEC 14 and network switch 16. The identification information for caller 15 may be obtained by using the VRU unit 15 as discussed above, with respect to FIG. 1.

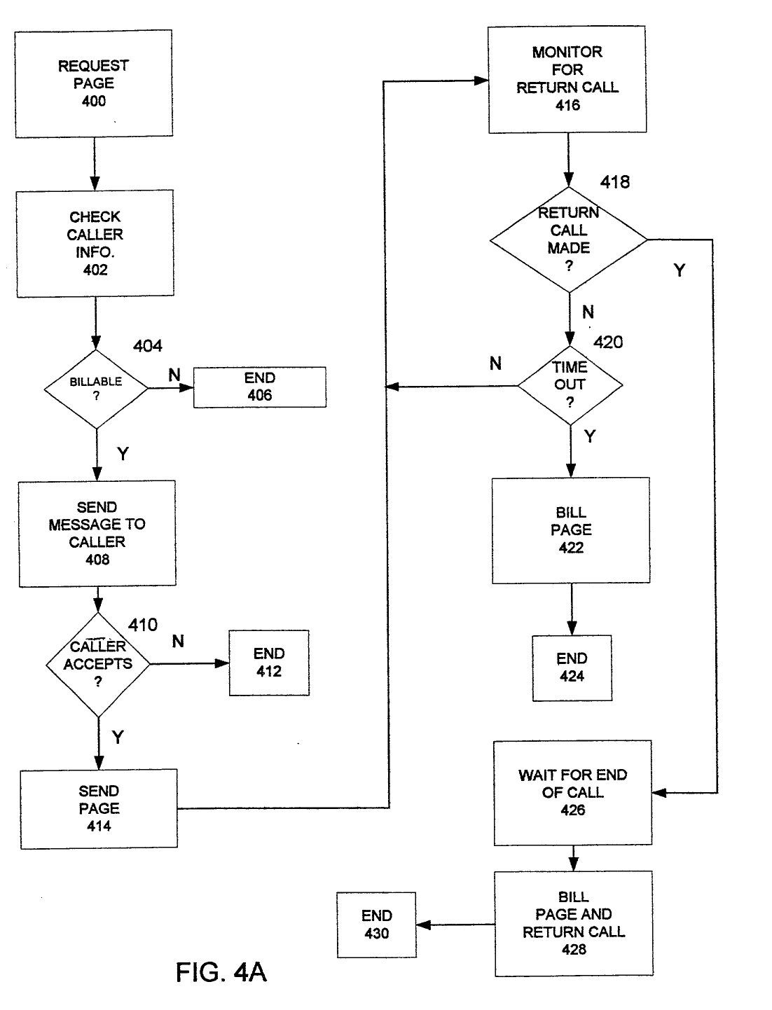

In step 206 the paging server 102 requests authorization to proceed with the page from payment server 102. The payment server 108 checks a data base 110 to determine if the page should be accepted. Details of the decision making are discussed below in conjunction with the flow chart of FIG. 4.

In step 208 a check is performed to determine if authorization was granted by the paging server 108. If not, then a message is sent to the caller 15 that the page was refused.

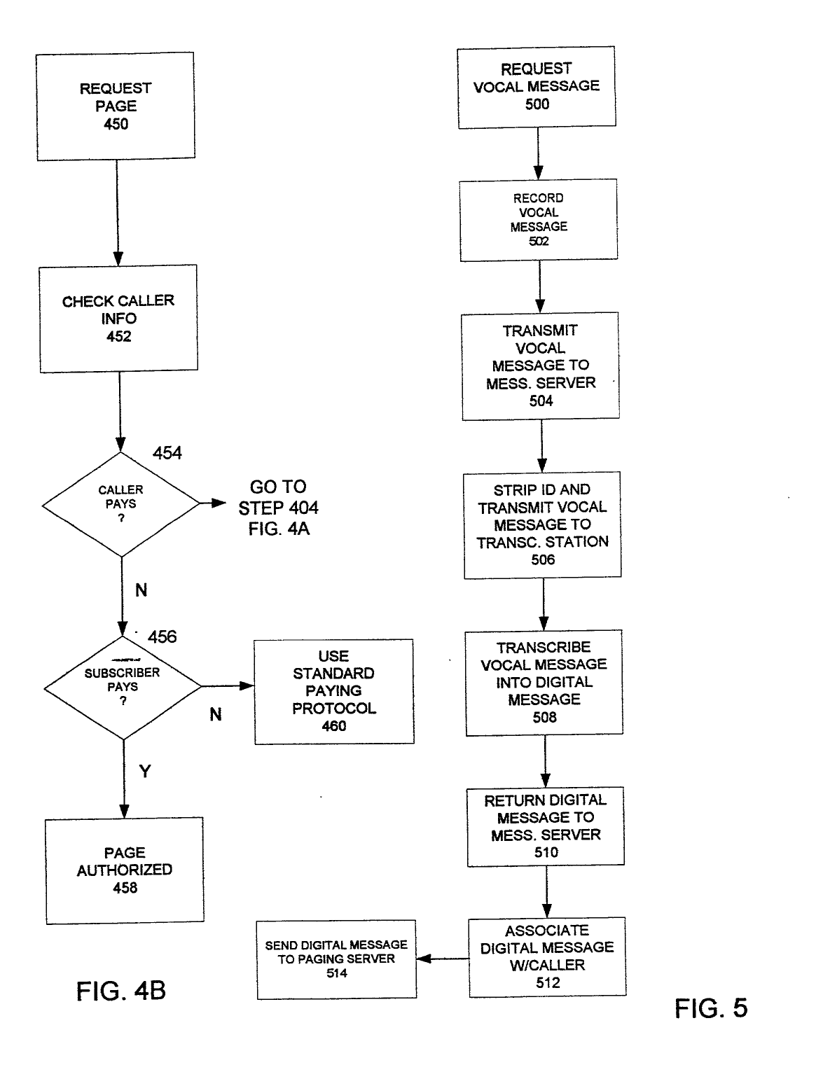

If the page is authorized in step 208 then in step 210 a check is performed to determine if the caller 15 desires to send some alphanumeric text to the pager 104. This feature of the system may be an option offered to the subscriber 24 when he registers his pager 20. During this step, a vocal message may be sent to the caller 15 asking if she would like to send an alphanumeric message as part of the page. Detail of how a text message is generated is discussed below in conjunction with the flow chart of FIG. 5.

If in step 210 it is decided that no text message needs to be generated then a paging signal is sent by paging server 102 to pager 20. In one embodiment of the invention, the paging signal consists merely of the caller ID for telephone set 12 or other similar information identifying the caller 15 to subscriber 24. This information is then sent to the pager 20 using a standard RF signal (step 214), and shown to subscriber 24 on display 26 (step 216).

If an alphanumeric message is desired in step 210, this message is generated in step 212. The message is then appended to the other information from paging server 102 and transmitted to the pager 20 and shown on display 26 as well.

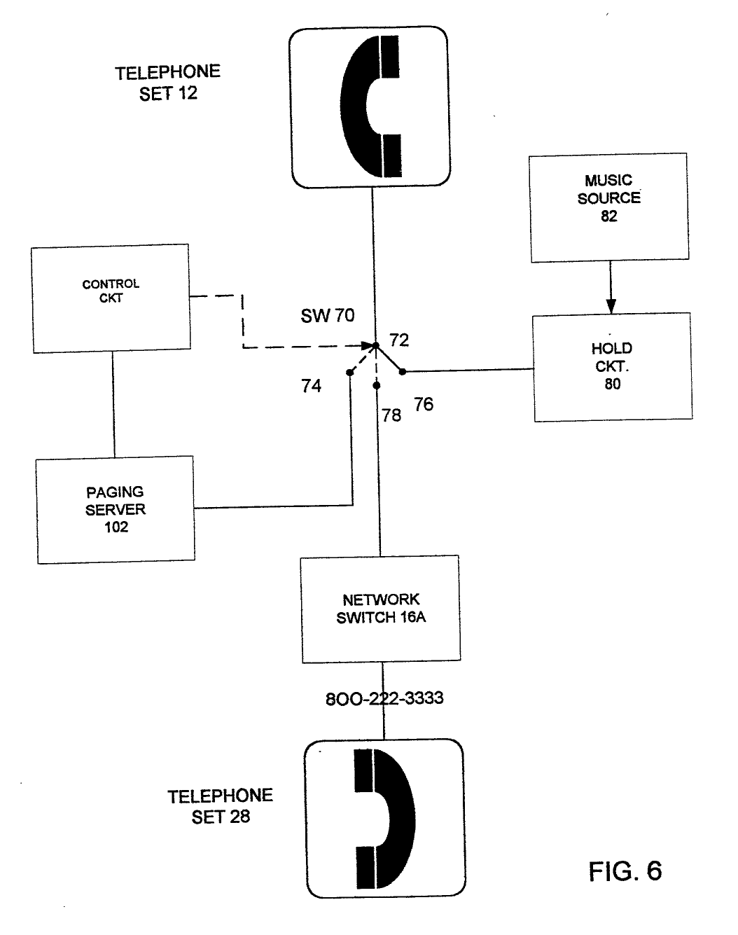

Immediately after a message is received, an annunciator (not shown) is activated to alert the subscriber 24 of the message. The subscriber then can read the message and then accesses a standard telephone 28 (step 218). In a preferred embodiment of the invention, the caller 15 stays on line for a predetermined time period. During this time, the subscriber calls a predetermined toll free number on telephone 28 and is then automatically connected to the set 12 so that he can talk to caller 15. This operation is described in more detail below in conjunction with the flow charts of FIGS. 4A and 6.

Referring now to the flow chart of FIG. 4A, a request for authorization for a page is received by server 108 on step 400. In step 402 the information available on caller 15 is checked to determine what kind of telephone set 12 is caller 15. This information may be obtained for example by checking the II code embedded in every call from the LEC 14. In step 404 a check is performed to determine if any charges can be billed to set 12. That is, a determination is made whether caller 15 is using a telephone set associated with a billable account. Examples of such telephone sets include a telephone in a domicile, a telephone in a business office or a telephone from a governmental office. Standard cellular telephones are also billable.

Telephones available to the general public such as public pay telephones in a library or museum, telephone sets from hospitals or hotels are not billable.

If in step 404 it is determined that no charges are billable to telephone set 12, then in step 406 the call is terminated and a message is sent to caller 15. Alternatively, the caller can be contacted and given the opportunity to pay by other means, such as by credit card. In this latter embodiment, the call is ruled billable after the credit card offered by the caller 15 is found to be valid.

If in step 404 the call for a page is found to be billable, then in step 408 a message is sent to the caller 15 asking her if she accepts the charges. If in step 410 the caller 15 declines then in step 412, the call is terminated. If the caller 15 accepts the charges then in step 414, the page is sent to the pager 22.

In step 416 the server 108 starts monitoring activity from the subscriber 24. More particularly, the server 108 checks at regular intervals (step 416) whether the subscriber 24 is making a return call to caller 15. Details of how this feature can be implemented are discussed below and in FIG. 6. If the subscriber 24 has not made any call to caller 15 in step 416, then in step 418 a check is performed to determine if a timer has timed out. This step is provided to allow the subscriber to return the call to caller 15 within a predetermined time, for example 10 minutes. If a timer has not timed out in step 420 then monitoring continues.

If in step 420 the timer has timed out then the server 108 determines the cost for the page, arranges for the payment to be paid charged to caller 15 (step 422) and then discontinues the page (step 424).

If in step 422, a return call to caller 15 is detected, then in step 426 the server 108 monitors that the communication between the caller 16 and subscriber 24. When the return call is completed from the subscriber 24 to the caller, the cost of the calling call is added to the cost the page and the sum is charged to the account of client 15 (step 428). The return call process is then terminated in step 430.

In an alternate embodiment of the invention, when subscriber 24 obtains the pager 20 he is given several options regarding payment for pages. For example, the subscriber 24 may be select one of the following payment options: (A) calling party pays always; (B) payment to be decided by subscriber; and (C) standard operation (subscriber pays for page and return call). The subscriber may also elect a combination of these options. For this purpose, the subscriber provides to the payment server 108 one or more lists of possible callers. For example one list could contain names or caller IDs of people from whom the subscriber expects pages and for whom the subscriber pays all the charges. Another list may comprise lists of people from whom the subscriber accepts pages if they (the callers) pay the page and the return call charges A third list may be established for people which will be treated as standard callers. In this manner a set of rules is established to handle pages from several callers, dependent on whether the callers appear on the lists. The rules defining the payment options, the lists and the options selected by each subscriber are stored by server 108 in its database 112.

The operation of the system describing a paging operation to a subscriber in accordance with this latter embodiment is now described in conjunction with the flow chart of FIG. 4B. First, a request for a page is received in step 450. In step 452 the information about caller 15 is checked against the lists provided by the subscriber 24. In step 454 a check is performed to determined if a caller is on the list of people for whom ‘the calling party pays’ option (or option A) has been selected. If so then the server moves to step 404 in FIG. 4A. If not, then in step 456 a check is performed if the caller is on the list of people for whom the subscriber pays all charges (option B). If so, then in step 458 the page is authorized and all charges associated with it, including the return call is charged to the account of the subscriber. If not, then the request for a page is charged in the same manner as in the standard paging systems (FIG. 1).

As previously discussed, one feature of the present invention is that a caller 15 may send alphanumeric messages to the pager 20. Of course if the caller can generate these alphanumeric messages herself, then they can be transmitted directly to the pager's display 26. However, in many instances the caller 15 does not have such facilities. In this latter case, alphanumeric messages are generated in step 212 of FIG. 1 as follows. Referring to FIG. 5, in step 500 the paging server 102 requests the caller 15 for her oral message that needs to be transcribed. In step 502 the oral message from the caller 15 is recorded digitally, using standard sampling techniques. In step 504 the digitized oral message is sent to a message server 116 together with a code identifying the caller 15. This message server 116 receives the message and the code. It then strips the code from the message, adds to it a different code and sends the digitized oral message to a transcribing station 118 (step 506).

At the transcribing station, digitized oral messages are converted into corresponding digital messages comprising alphanumeric characters. This process can be performed by persons who listen to the oral message (which is converted into an analog form for this purpose) and then generate a corresponding digital message using a standard PC or other well known means (step 508).

Next, in step 510, the digital message is returned to the message server 116 with the code initially received. In step 512 the message server 116 associates the digital message with the proper caller and then transmits the message with an identifying code to the paging server 102. The paging server 102 then processes the message as described above and shown in FIG. 3. In this manner oral messages are quickly transcribed into digital messages.

Some present paging systems also have the capability of sending digital messages to pagers however, these systems use live operators who receive a call from a caller, request a number for the subscriber, request the oral message to be sent, transcribe the oral message into a digital message and then send the digital message to the respective pager. This process is time consuming and labor intensive. In the present system the process has been automated to a large extent. Only the actual transcribing process needs human intervention. Moreover the transcription can be performed off line so that it is easier to manage. However since the people at the transcribing station perform only transcription, the process is performed more efficiently then when an attendant must handle all details required to complete a connection to a pager.

The components that allow provide an automatic connection for a return call and to charge the return call to the caller is now described. Referring to FIG. 1, it will be recalled that in order to perform a normal return call, subscriber 24 accesses a telephone set 28 and dials the number of caller 15, such as 212-111-1111. This call goes to the network switch 16. Network switch 16 then switches the call to LEC 14 and telephone set 12.

However, in the present invention, a simpler process is provided as follows. First, a special toll-free number is assigned, such as 800-222-3333, to the pager 20 by pager server 102. This number can be permanently assigned to subscriber 24 so that he can perform a return call by dialing this number every time he gets a page. Alternatively, a number is assigned and transmitted to a pager each time a page is received. This latter arrangement is useful if only small amount of such numbers are available.

When the subscriber 24 dials the assigned number, the subscriber's return call is directed to the network switch 16A. The network switch 16A recognizes the subscriber from the dialed number and directs the call to a conference switch 106. The conference switch 106 can be incorporated into the paging server 102, however, it is shown in the Figures as a separate entity for the sake of clarity.

Referring now to FIG. 6, the conference switch 106 may be represented schematically as a multi-position switch 70 controlled by the paging server 102. The switch 70 has an input terminal 72 and three output terminals 74, 76, 78. Terminal 74 is connected to the paging server 102. Terminal 76 is connected to a hold circuit 80, which may receive a feed from a musical source 82. Terminal 78 is connected to network switch 16A. Thus, the switch 70 can have three positions: a SERVER CONNECT position in which the input terminal 72 is connected to terminal 74, a HOLD position in which the input terminal 72 is connected to terminal 76 and a CONFERENCE position in which the input 72 is connected to terminal 78.

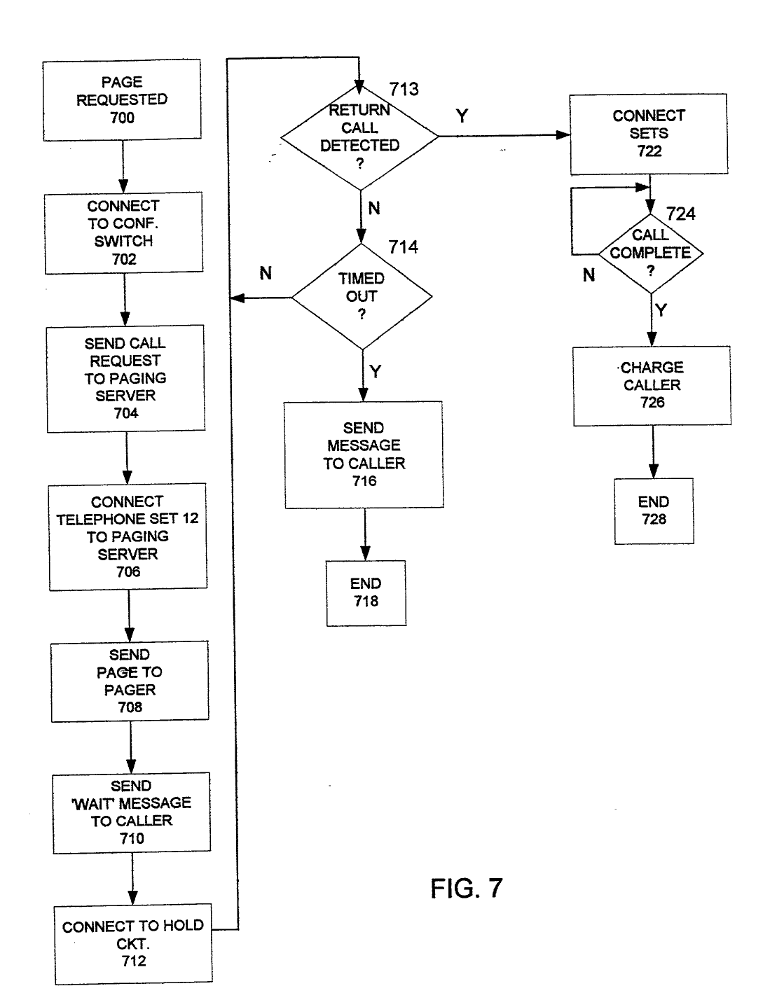

Details of the operation of the circuit of FIG. 6 are now provided in conjunction with the flow chart of FIG. 7. In step 700 caller 15 places a request for a page. In step 702 the telephone set 12 is connected by network switch 16A to conference switch 106 (terminal 72 in FIG. 6). In step 704 the page is sent to the switching server 102. If further communication is required with the telephone set 12, or caller 15, in step 706 the switch 70 is positioned to allow the telephone set 12 to be connected to output 74 and paging server 102. In step 708 the page is sent by the paging server 102 to pager 20, as discussed above and described in FIGS. 4A and 4B. In step 710 the paging server 102 sends a ‘WAIT’ message to caller 15 indicating that the page has been sent and that subscriber 24 should be on line shortly. In step 712 the switch 70 connects the telephone set 12 to hold circuit 80. Optionally, music from source 82 is provided to the caller 15 through hold circuit 80.

In order to make a return call, the subscriber 24 has to dial his designated number. At regular intervals a check is performed in step 713 to determine if a call has been received from subscriber 24. If no such call has been received in step 713, than in step 714 a check is made to determine if a predetermined time (for example, 10 minutes) has expired since the page has been sent. If the time has expired or timed out then in step 716 a message is sent to the caller 15 that subscriber 24 has not returned the call in response to the page and in step 718 the process is terminated.

If in step 714 the preset time has not expired then the switch 70 is maintained in the HOLD position.

Going back to step 713 if a return call from subscriber 24 is detected, then in step 722 the switch 70 is positioned to the CONFERENCE position and the telephone set 12 is connected to telephone set 28 thereby allowing communication between caller 15 and subscriber 24.

In step 724 the call is monitored. When the call is completed (i.e., when either the caller 15 or subscriber 24 hangs up) the caller 15 is charged (step 726), as discussed in detail above and the flow chart of 4A and the process is terminated (step 726). The cost of maintaining the connection between the network server 16A and the telephone set 12 while the caller 15 is waiting for the return call can be charged either to the caller, or by the paging service.

The toll-free number assigned to the subscriber 24 may be a permanent number and hence the subscriber 24 can dial the same number every time the subscriber 24 gets a call. When the subscriber 24 dials his designated toll-free number, the paging server 102 recognizes subscriber 24 from the number dialed and connects him to the proper caller 15.

In an alternative embodiment of the invention, either all, or a group of subscribers are assigned the same toll-free number but each subscriber can be given a designated code. In this embodiment, after the subscriber 24 dials the common toll-free number, he then receives a request from the paging server 102 to dial his designated code. The paging server 102 recognizes the subscriber 24 from his designated code.

In another embodiment of the invention, a toll-free number (or a code) is designated for each subscriber only for a particular return call. The toll-free number or code is transmitted to the caller as part of the page. After the return call is terminated, the toll-free number or code is no longer valid and the subscriber has to get another one with the next page that he receives.

The various elements of the invention are shown in the drawings as separate and distinct elements for the sake of clarity. It should be understood that these elements, such as the paging server 102, the payment server 108, the database 112, the message server 116, the transcription station 118 and the conference switch 106 may be combined into a single unit.

In summary, a ‘calling party pays’ paging system is presented which is arranged to charge all costs associated with a page (including the cost of the return call) to be charged to the calling party. Other options are also available which allow a paging party subscriber to receive pages from a specific caller with the subscriber paying the costs involved. The return call, when paid for by the calling party, is implemented by providing a toll-free number to the subscriber and charging the calling party for the call. In addition, a transcription mode of operation is also described in which vocal messages are transcribed into digital signals off-line and then transmitted as part of a page to a pager then displays the digital message as an alphanumeric message to the subscriber.

The paging system described herein is advantageous for both the operator of the paging server system and its subscribers. The paging system operator benefits from the unique features of the system which make it attractive to a large number of subscribers. Morever, since the subscribers do not have pay for pages, the system can attract subscribers who normally would be interested in obtaining pagers because of cost constraints. Subscribers benefit because they can use standard pagers identical to the pagers used in existing systems, but they do not get charged for the pages. Moreover they are now capable of getting text messages as well. Finally, the automatic call back eases the process of completing the return call process, and moreover, it is very user friendly since the subscribers do not pay for it.

Obviously numerous modifications may be made to the invention without departing from its scope defined in the appended claims.

We claim:

1. A paging system for sending a message to a subscriber of the system comprising:
a pager adapted to receive a page and to display a message from a caller to a subscriber;
a paging server adapted to receive a request for sending said page, said request including information about the caller; and
a payment server coupled to said paging server and adapted to charge one of said caller and said subscriber in accordance with predetermined rules.

2. The paging system of claim 1 wherein said payment server and said paging server cooperate to deliver said page to said pager only of said payment server determines a method of payment for said page.

3. The paging system of claim 1 further comprising a conference switch responsive to a return call from said subscriber, said conference switch adapted to establish a communication link between said subscriber and said caller.

4. The paging system of claim 3 wherein said paging server is adapted to charge said one of said subscriber and said caller for said page and said return call.

5. The paging system of claim 1 further comprising a caller identifier that identifies an account associated with said caller, wherein said payment server charges said account for said page.

6. A paging system arranged to deliver selectively a page from a caller to a subscriber, said page including information descriptive of said caller and to facilitate a return call from said subscriber, said system comprising:
a paging server that receives a page request by the caller and generates in response a page to a subscriber, said page including information identifying said caller;
a pager having a display and arranged to receive said page and to show on said display a message to the subscriber, said message including data based on said information; and
a switch coupled to said page server and the caller and arranged to respond to a return call request from the subscriber by automatically establishing communication between said subscriber and said caller.

7. The paging system of claim 6 wherein said switch is adapted to establish said communication when said caller remains connected after making said page request.

8. The paging system of claim 6 wherein said caller is associated with a caller telephone number and wherein said switch is responsive to a number from said subscriber which is different from said caller telephone number.

9. The paging system of claim 8 wherein said switch is responsive to a toll free number whereby said subscriber does not pay for said return call.

10. The paging system of claim 9 wherein said pager server is arranged to generate a charge for said page.

11. The paging system of claim 9 wherein said pager server is adapted to charge the caller for said page.

12. The paging system of claim 6 further comprising a payment server coupled to said pager server, said payment server being adapted to generate a charge associated with said page and said return call.

13. The paging system of claim 12 wherein said payment server is adapted to identify an account associated with said caller, said charge being sent to said account.

14. The paging system of claim 13 wherein said caller is associated with telephone set, said payment server being adapted to determine said account from said telephone set.

15. The paging system of claim 6 further comprising a text transcriber station for transcribing vocal messages from the caller into digital messages.

16. The paging system of claim 15 wherein said paging server is adapted to send said digital messages to said pager.

17. A method of sending a page to a pager of a subscriber comprising:
generating a page request by a caller, said page request including information identifying the caller;
receiving said page request and generating a corresponding page, said page including a number associated with said caller;
transmitting said page to said pager;
receiving a return call request from the subscriber; and
automatically establishing a voice channel between said subscriber and said caller in response to said return call request.

18. The method of claim 17 wherein said caller is associated with a caller telephone number and wherein said return request is generated by the subscriber by using a return call number different then said caller telephone number.

19. The method of claim 17 further comprising putting the caller on hold after said page request is generated and in response to said return call request establishing said voice channel between the caller and subscriber by removing said hold.

20. The method of claim 17 further comprising generating a charge for said page.

21. The method of claim 17 further comprising generating a charge for said page and said return call.

22. The method of claim 21 further comprising obtaining a caller account associated with the caller and applying said charge to said account.

23. The method of claim 21 further comprising providing a set of rules based on an identity of the callers and generating a charge based on said rules.

24. The method of claim 23 further comprising selecting said set of rules by the subscriber.

25. A method of transmitting a page from a caller to a subscriber of a paging system, said paging including alphanumeric text, comprising:
generating a page request and a vocal message by the caller;
receiving said page request and said vocal message by a paging server;
transmitting said vocal message to a transcribing station;
generating a digital message corresponding to said vocal message at said transcribing station;
returning said digital message to said paging server;
transmitting a page in response to said page request to a pager, said page including said digital message; and
displaying said digital message on said pager.

26. The method of claim 25 wherein said paging server sends a code together with said vocal message to said transcription station and wherein said transcription station returns said digital message with said code to identify the caller associated with said vocal message.
